(19) United States
(12) Patent Application Publication
(10) Pub. No.: US 2013/0038068 A1
(43) Pub. Date: Feb. 14, 2013

(54) Compounded Wind Power Generator

(71) Applicants: Chang-Hsien Tai, Neipu Hsiang (TW); Uzu-Kuei Hsu, Neipu Hsiang (TW); Shi-Wei Lo, Neipu Hsiang (TW)

(72) Inventors: Chang-Hsien Tai, Neipu Hsiang (TW); Uzu-Kuei Hsu, Neipu Hsiang (TW); Shi-Wei Lo, Neipu Hsiang (TW)

(21) Appl. No.: 13/276,361

(22) Filed: Oct. 19, 2011

(30) Foreign Application Priority Data
Aug. 9, 2011 (TW) 100128430

(51) Int. Cl. F03D 9/00; F03D 7/04

(52) U.S. Cl. 290/55; 415/147

(57) ABSTRACT

A compounded wind power generator includes a first tube, a second tube, a blocking member and an electricity-generating assembly. The first tube has a first end and a second end. The first end has an air inlet. The first tube forms a first air channel therein. The second tube is disposed in the first air channel of the first tube and forms a second air channel therein. The blocking member is connected between the first tube and the second tube and has a plurality of panels. Each of the panels has one end abutting against the second tube, and the end of each of the panels is capable of being disengaged from the second tube by wind. The electricity-generating assembly is disposed in the first air channel.

### BACKGROUND OF THE INVENTION

1. Field of the Invention

The present invention generally relates to a wind power generator and, more particularly, to a wind power generator that adapts different mechanisms to generate power according to different wind strengths.

2. Description of the Related Art

Wind power generation has been a very important renewable energy that provides human with required electricity while meeting the requirements of environmental protection at the same time. In wind power generation, natural wind can drive blades of a wind power generator to rotate. In turn, the rotating blades can drive a generator to generate electricity. This electricity generation mechanism meets the modern environmental requirements.

Referring to FIG. 1, a conventional tube-type wind power generator 9 includes an air-guiding tube 91 and an axial-type generator 92. The air-guiding tube 91 can receive and deliver natural wind to the axial-type generator 92. The air-guiding tube 91 can concentrate the wind on the axial-type generator 92 to improve electricity generation efficiency of the axial-type generator 92.

The axial-type generator 92 is mainly driven by natural wind. However, the wind is not always in a constant strength. For example, when the wind is strong, the air-guiding tube 91 can efficiently collect air for driving the axial-type generator 92. To the contrary, when the wind is weak, less air is collected by the air-guiding tube 91. Since the air-guiding tube 91 has a fixed diameter, the speed of the air cannot be increased, resulting in poor electricity generation efficiency. As a result, the performance of the wind power generator 9 is unstable.

### SUMMARY OF THE INVENTION

It is therefore the primary objective of this invention to provide a compounded wind power generator that controls the incoming air to flow in one or two tubes with varying diameters according to different wind strengths. Thus, the compounded wind power generator can provide improved power generation efficiency in smaller wind strength.

The invention discloses a compounded wind power generator comprising a first tube, a second tube, a blocking member and an electricity-generating assembly. The first tube has a first end and a second end. The first end has an air inlet. The first tube forms a first air channel therein. The second tube is disposed in the first air channel of the first tube and forms a second air channel therein. The blocking member is connected between the first tube and the second tube and has a plurality of panels. Each of the panels has one end abutting against the second tube, and the end of each of the panels is capable of being disengaged from the second tube by wind. The electricity-generating assembly is disposed in the first air channel.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a conventional wind power generation structure.

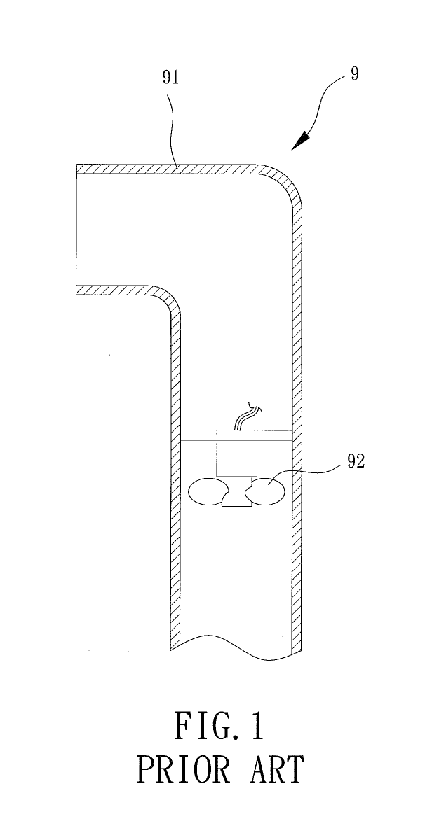

FIG. 2 shows a compounded wind power generator according to a preferred embodiment of the invention.

FIG. 3 is an exploded view of a blocking member of the compounded wind power generator of the invention.

FIG. 4 shows a state of the blocking member when the wind is in a smaller strength.

FIG. 5 shows another state of the blocking member when the wind is in a larger strength.

FIG. 6 shows an operation diagram of the compounded wind power generator when the wind is in smaller strength, including the path of the incoming air.

FIG. 7 shows another operation diagram of the compounded wind power generator when the wind is in larger strength, including the path of the incoming air.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

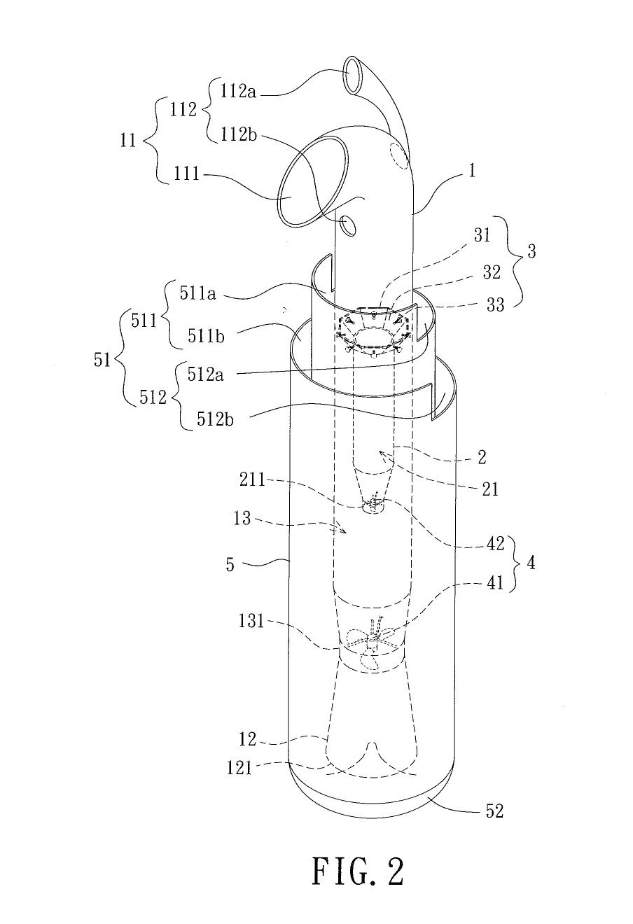

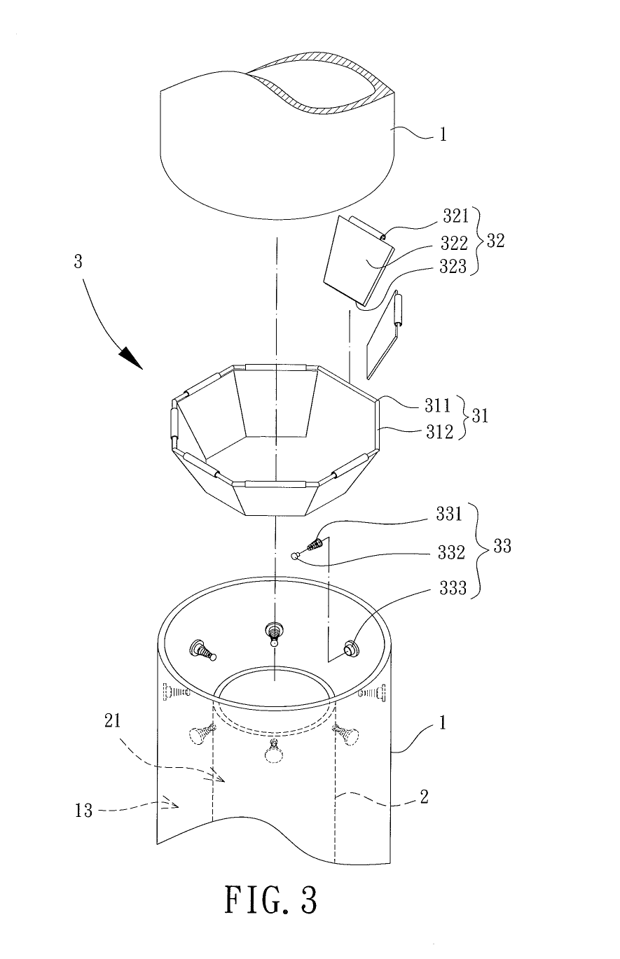

Referring to FIGS. 2 and 3, a compounded wind power generator including a first tube 1, a second tube 2, a blocking member 3 and an electricity-generating assembly 4 is disclosed according to a preferred embodiment of the invention. The second tube 2 is disposed in the first tube 1. The blocking member 3 is connected between the first tube 1 and the second tube 2. The electricity-generating assembly 4 is disposed in the first tube 1 and the second tube 2.

The first tube 1 is a hollow tube having a first end 11 and a second end 12. The first end 11 has an air inlet 111 that is set in a direction facing the wind for collecting air. The first end 11 of the first tube 1 can extend in the radial direction to collect air more efficiently. The first tube 1 can include at least one set of air-guiding holes 112 where the first tube 1 bends. However, the set of air-guiding holes 112 can also be arranged on other position of the first tube 1. In a preferred case shown in the embodiment, the set of air-guiding holes 112 includes a first air-guiding hole 112a and a second air-guiding hole 112b. The first air-guiding hole 112a is located above the first tube 1 to provide a ventilation effect for the first tube 1. This avoids a high pressure from forming above the first tube 1 when the wind blows over the wind power generator. The second air-guiding hole 112b is arranged on a throat of the first tube 1 where the first tube 1 bends at the first end 11 of the first tube 1. The second air-guiding hole 112b can provide another ventilation effect for the first tube 1, so that turbulence can be avoided from forming at the throat when the incoming air changes its direction at the throat.

The first tube 1 has a first air channel 13 which preferably forms a first narrow portion 131 between the first end 11 and the second end 12 of the first tube 1. Therefore, based on the reduced diameter of the first narrow portion 131, the air in the first air channel 13 can be speeded up when passing through the first narrow portion 131. In this embodiment, the first air channel 13 has a fixed diameter between the first end 11 and a predetermined location near the first narrow portion 131. The diameter of the first air channel 13 starts to reduce in a gentle way from the predetermined location to the first narrow portion 131. After the first narrow portion 131, the diameter of the first air channel 13 starts to increase all the way to the second end 12.

The second tube 2 is a hollow tube disposed in the first air channel 13 of the first tube 1. The second tube 2 has a second air channel 21 with a smaller diameter than the first air channel 13. The second air channel 21 communicates with the first air channel 13 and has a second narrow portion 211. Similar to the first narrow portion 131, the air in the second air channel 21 can be speeded up when passing through the second narrow portion 211.

Referring to FIG. 3, the blocking member 3 has one end abutting against an inner circumferential wall of the first tube 1, as well as the other end movably abutting against the second tube 2. When the wind is not strong, all the air in the first air channel 13 flows into the second air channel 21. When the wind is strong, the air flowing down the first tube 1 blows on the blocking member 3 so hard that the blocking member 3 disengages from the second tube 2, allowing the air to flow in the first air channel 13 and the second air channel 21 at the same time. The blocking member 3 includes a frame 31, a plurality of panels 32 and a plurality of elastic assemblies 33. However, the structure and operation details of the blocking member 3 are not limited thereto.

The frame 31 may be a polygonal frame having a plurality of vertexes and a plurality of sides. In a preferred case, the frame 31 is an octagonal frame having a plurality of connection portions 311 and a plurality of hooked portions 312, with the connection portions 311 forming eight vertexes and the hooked portions 312 forming eight sides. The connection portions 311 may be coupled with the inner circumferential wall of the first tube 1 by conventional ways such as welding. Each panel 32 has a hooking portion 321, an air-blocking portion 322 and an abutting portion 323. Through the hooking portion 321, the air-blocking portion 322 of one panel 32 may be movably hooked on a corresponding hooked portion 312 of the frame 31. At this point, the air-blocking portion 322 is located in the first air channel 13 and connected between the first tube 1 and the second tube 2, with one end of the air-blocking portion 322 tightly coupling with the circumferential wall of the first tube 1 while the other end of the air-blocking portion 322 movably abutting against the second tube 2.

The quantity of the elastic assemblies 33 corresponds to that of the panels 32. Each elastic assembly 33 has an elastic element 331, an abutting portion 332 and a fixing seat 333. The elastic element 331 has one end connected to the abutting portion 332, as well as the other end connected to the fixing seat 333. The fixing seat 333 may have a chamber that can receive the elastic element 331 when the elastic element 331 is pressed by an external force. The fixing seat 333 is arranged on the inner circumferential wall of the first tube 1. The abutting portion 332 abuts against a face of a corresponding panel 32. The elastic elements 331 may provide a supporting force for the panels 32 and can be pressed by the external force, thereby allowing the abutting portions 323 of the panels 32 to abut against and disengage from the second tube 2.

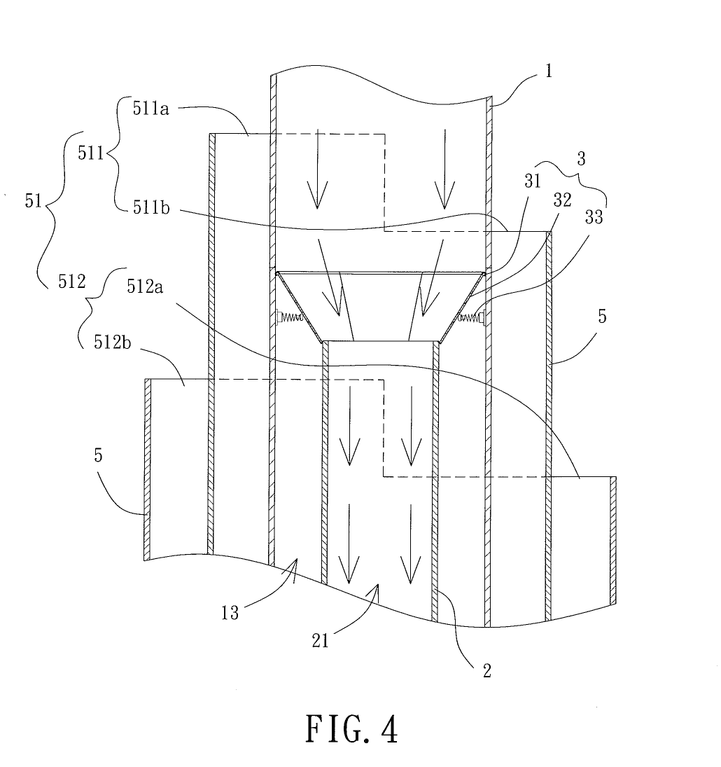

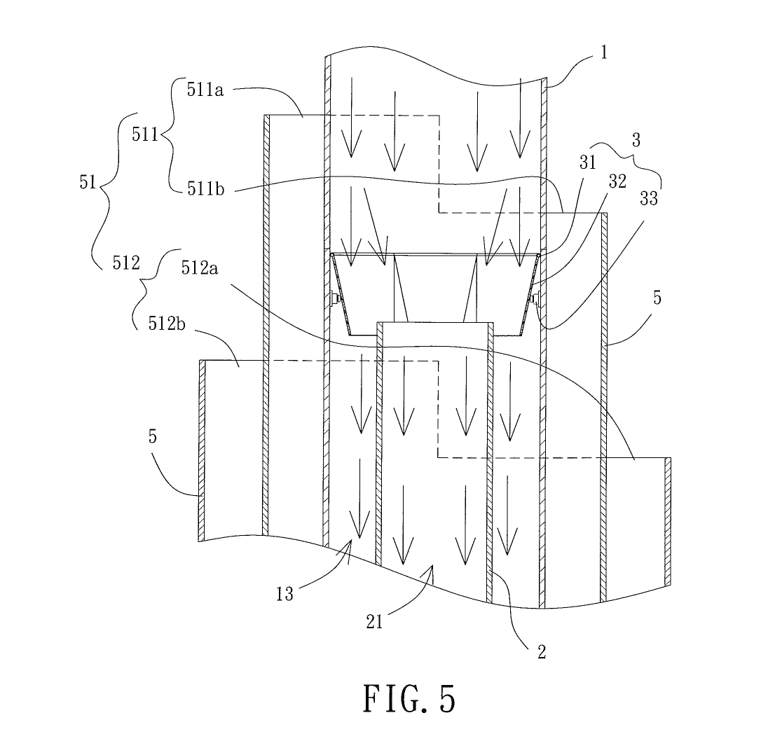

Referring to FIGS. 4 and 5, when the wind is not strong, the incoming air applies a smaller force to the panels 32 than the supporting force the elastic elements 331 apply to the panels 32. Thus, the abutting portions 323 of the panels 32 tightly abut against the second tube 2. In this situation, the air in the first air channel 13 is blocked by the air-blocking portions 322 and guided into the second air channel 21. To the contrary, when the wind is strong, the incoming air applies a larger force to the panels 32 than the supporting force the elastic elements 331 apply to the panels 32. As a result, the panels 32 press the elastic assemblies 33, squeezing the elastic elements 331 into the chambers of the fixing seats 333. Thus, the abutting portions 323 of the panels 32 disengage from the second tube 2, forming a gap between the abutting portions 323 and the second tube 2. In this situation, the incoming air flows in both the first air channel 13 and the second air channel 21.

The electricity-generating assembly 4 is disposed in the first air channel and the second air channel 21. In this embodiment, the electricity-generating assembly 4 includes a first axial-type generator 41 and a second axial-type generator 42. The first axial-type generator 41 is preferably disposed in the first narrow portion 131 of the first air channel 13. The second axial-type generator 42 is preferably disposed in the second narrow portion 211 of the second air channel 21. When the wind is strong enough, the incoming air pushes open the panels 32, allowing the air to flow in both the first air channel 13 and the second air channel 21. Thus, the first axial-type generator 41 and the second axial-type generator 42 are simultaneously driven at the same time. To the contrary, when the wind is not strong, the abutting portions 323 of the panels 32 tightly abut against the second tube 2. Therefore, the incoming air enters only the second air channel 21 to drive the second axial-type generator 42.

To further improve the air-collecting effect, the compounded wind power generator may further include a third tube 5. The third tube 5 receives the first tube 1 and the second tube 2, and includes an opening end 51 and a closed end 52. The opening end 51 has a plurality of windward openings 511 and a plurality of air-guiding openings 512. In the embodiment, the opening end 51 has a first windward opening 511a, a second windward opening 511b, a first air-guiding opening 512a and a second air-guiding opening 512b. The first windward opening 511a is higher than the first air-guiding opening 512a, and the second windward opening 511b is higher than the second air-guiding opening 512b. An exhaust channel 53 is formed between the third tube 5 and the first tube 1. A gap 121 is formed between the closed end 52 of the third tube 5 and the second end 12 of the first tube 1, such that the first air channel 13 can communicate with the exhaust channel 53 via the gap 121.

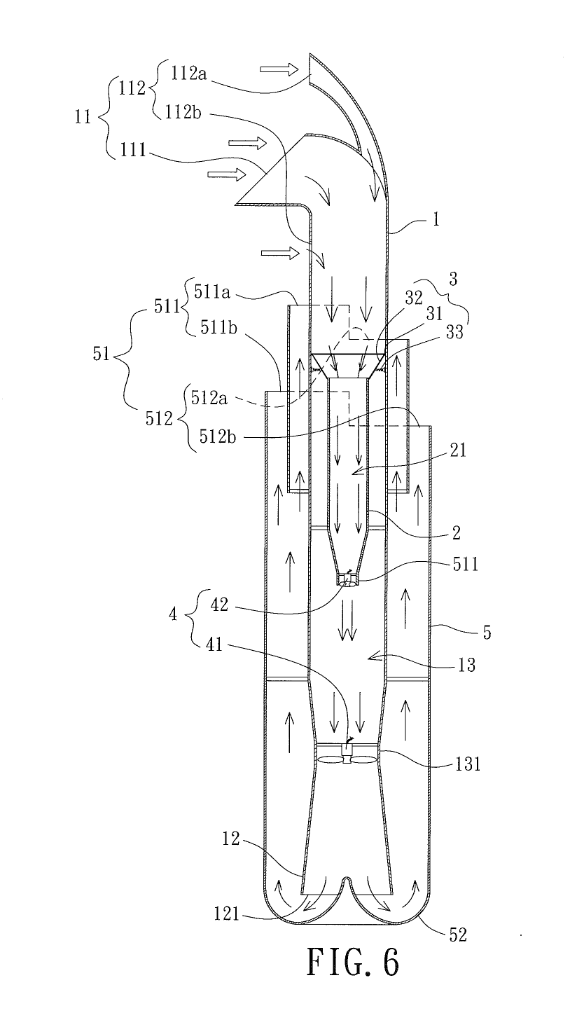

Specifically, referring to FIG. 6, the compounded wind power generator of the invention collects air via the air inlet 111, and the collected air flows in the first air channel 13. The high-pressure turbulence effect that takes place where the first air channel 13 bends can be reduced by the air-guiding effect provided by the first air-guiding hole 112a and the second air-guiding hole 112b, thereby allowing the collected air to smoothly flow in the first air channel 13. When the wind is not strong, the force acted upon the panels 32 by the incoming air is smaller than the supporting force the elastic elements 331 apply to the panels 32. Thus, the abutting portions 323 of the panels 32 tightly abut against the second tube 2, guiding the air of the first air channel 13 to the second air channel 21. Since the second air channel 21 has a smaller diameter than the first air channel 13, the air is speeded when entering the second air channel 21 from the first air channel 13. When the air enters the second narrow portion 211 from the second air channel 21, the air is speeded up again due to the reduction of diameter of the second tube 2. At this moment, the air in the second narrow portion 211 flows faster than where it is at the air inlet 111, thereby efficiently driving the second axial-type generator 42 in the second narrow portion 211.

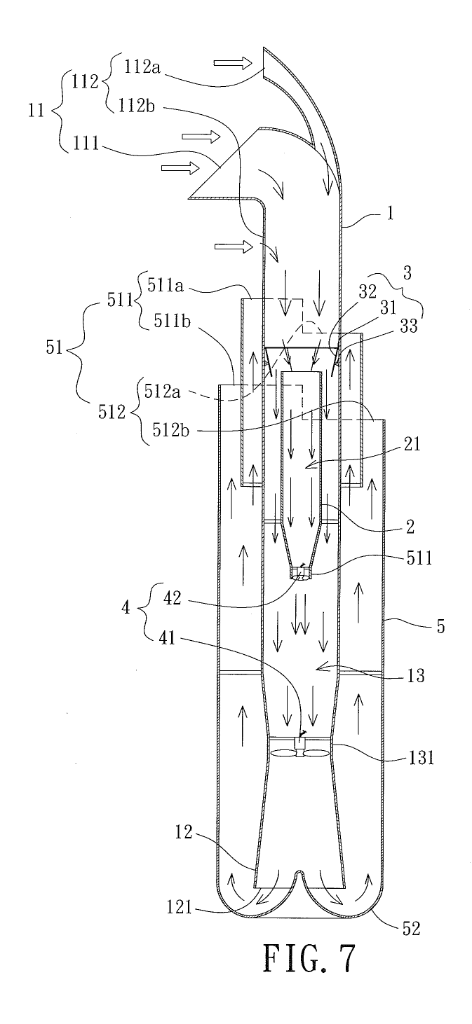

Referring to FIG. 7, when the wind is strong, the force acted upon the panels 32 by the incoming air is larger than the supporting force the elastic elements 331 apply to the panels 32. At this time, the incoming air forces the abutting portions 323 of the panels 32 to disengage from the second tube 2. Thus, the incoming air flows in both the first air channel 13 and the second air channel 21. As stated above, the air is speeded up when entering the second narrow portion 211 from the second air channel 21 due to reduction of diameter of the second tube 2, efficiently driving the second axial-type generator 42. After the second air channel 21, the airflows in the second air channel 21 and the first air channel 13 come together again. The airflows then pass the first narrow portion 131 of the first air channel 13 and are speeded up in the first narrow portion 131 due to reduction of diameter of the first tube 1, thereby driving the first axial-type generator 41 efficiently. Thus, the electricity-generating assembly 4 is efficiently driven to provide double electricity generation mechanisms.

Since the gap 121 is formed between the closed end 52 of the third tube 5 and the second end 12 of the first tube 1, the first air channel 13 communicates with the exhaust channel 53 via the gap 121. Regardless of wind strength, the air must enter the exhaust channel 53 via the gap 121, and is expelled from the exhaust channel 53 via the windward openings 511 and the air-guiding openings 512. The windward openings 511 are preferably set in a direction facing the wind so that the wind can bring the air, which is expelled from the windward openings 511, to the air-guiding openings 512. Since the first windward opening 511a and the second windward opening 511b are respectively higher than the first air-guiding opening 512a and the second air-guiding opening 512b, the air from the windward openings 511 interacts with the air of the air-guiding openings 512, creating a relatively lower air pressure at the air-guiding openings 512. This enhances an air-pulling effect at the air-guiding openings 512. Thus, the air in the exhaust channel 53 can be rapidly expelled to increase the speed of the air entering the compounded wind power generator. As such, overall electricity generation efficiency is improved.

The compounded wind power generator of the invention can assign the incoming air to flow in one or two tubes with varying diameters according to wind strength. Therefore, different power generation mechanisms are adapted in different wind strengths to optimize the power generation efficiency. Thus, the compounded wind power generator of the invention can be used in different wind strengths while providing optimized performance.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A compounded wind power generator, comprising:
a first tube having a first end and a second end, wherein the first end has an air inlet, and the first tube forms a first air channel therein;
a second tube disposed in the first air channel of the first tube, wherein the second tube forms a second air channel therein;
a blocking member connected between the first tube and the second tube and having a plurality of panels, wherein each of the panels has one end abutting against the second tube, and the end of each of the panels is capable of being disengaged from the second tube by wind; and
an electricity-generating assembly disposed in the first air channel.

2. The compounded wind power generator as claimed in claim 1, wherein each of the panels has a hooking portion and an abutting portion.

3. The compounded wind power generator as claimed in claim 2, wherein the blocking member includes a frame having a plurality of connection portions and a plurality of hooked portions, the connection portions are coupled with an inner circumferential wall of the first tube, and the hooking portion of each of the panels is movably hooked on a respective one of the hooked portions of the frame.

4. The compounded wind power generator as claimed in claim 3, wherein the frame is a polygonal frame.

5. The compounded wind power generator as claimed in claim 2, wherein the blocking member includes a plurality of elastic assemblies corresponding to the panels, each of the elastic assemblies has one end connected to the inner circumferential wall of the first tube, as well as an other end abutting against a face of a respective one of the panels, thereby allowing the abutting portions of the panels to movably abut against the second tube.

6. The compounded wind power generator as claimed in claim 5, wherein each of the elastic assemblies has an elastic element, an abutting portion and a fixing seat, the elastic element has one end connected to the abutting portion, as well as an other end connected to the fixing seat, the abutting portion abuts against the face of a respective one of the panels, and the fixing seat is arranged on the inner circumferential wall of the first tube.

7. The compounded wind power generator as claimed in claim 6, wherein the fixing seat has a chamber capable of receiving the elastic element when the elastic element is pressed.

8. The compounded wind power generator as claimed in claim 1, wherein the first tube has a set of air-guiding holes at the first end thereof.

9. The compounded wind power generator as claimed in claim 8, wherein the set of air-guiding holes includes an air-guiding hole located above the first tube.

10. The compounded wind power generator as claimed in claim 8, wherein the set of air-guiding holes includes an air-guiding hole on a throat of the first tube where the first tube bends at the first end of the first tube.

11. The compounded wind power generator as claimed in claim 1, wherein the first air channel of the first tube forms a narrow portion.

12. The compounded wind power generator as claimed in claim 1, wherein the second air channel of the second tube forms a narrow portion.

13. The compounded wind power generator as claimed in claim 11, wherein the first air channel has a diameter that is gradually-increased from an end of the narrow portion to the second end of the first tube.

14. The compounded wind power generator as claimed in claim 11, wherein the electricity-generating assembly includes an axial-type generator disposed in the narrow portion of the first air channel.

15. The compounded wind power generator as claimed in claim 12, wherein the electricity-generating assembly includes an axial-type generator disposed in the narrow portion of the second air channel.

16. The compounded wind power generator as claimed in claim 1, further comprising a third tube receiving the first tube and including an opening end and a closed end, wherein an exhaust channel is formed between the third tube and the first tube, and a gap is formed between the closed end of the third tube and the second end of the first tube, allowing the first air channel to communicate with the exhaust channel via the gap.

17. The compounded wind power generator as claimed in claim 16, wherein the opening end of the third tube includes a plurality of windward openings and a plurality of air-guiding openings corresponding to the windward openings.

18. The compounded wind power generator as claimed in claim 17, wherein each of the windward openings is higher than one of the air-guiding openings corresponding thereto.
